(19) United States
(12) Patent Application Publication
(10) Pub. No.: US 2014/0222703 A1
(43) Pub. Date: Aug. 7, 2014

(54) System and Method For Efficient Messaging and For Populating Activity Streams

(71) Applicant: Strum, Inc., Toronto (CA)

(72) Inventor: D. Andrew C. Smith, Toronto (CA)

(73) Assignee: Strum, Inc., Toronto (CA)

(21) Appl. No.: 14/168,182

(22) Filed: Jan. 30, 2014

Related U.S. Application Data
(60) Provisional application No. 61/760,283, filed on Feb. 4, 2013.

(51) Int. Cl. G06Q 50/00; H04L 12/58

(52) U.S. Cl. CPC G06Q 50/01; H04L 51/32
USPC 705/319

(57) ABSTRACT

Systems and methods which facilitate efficient messaging and populating an activity stream are disclosed. In an aspect, a communication and feedback platform is disclosed which enables customers to provide public or private feedback messages to a business. Feedback messages may be tagged with employee information (further facilitated with appropriate privacy controls), thereby enabling the business to receive information about the performance of a specific employee via the platform. The platform further comprises a points allocation module, the points being redeemable via a reward engine.

### CROSS REFERENCE TO RELATED APPLICATION

This application claims the benefit of U.S. Provisional Patent Application No. 61/760,283, filed Feb. 4, 2013, and entitled “System and Method For Populating Activity Streams”, the entire contents of which is incorporated herein by reference.

### FIELD OF THE DISCLOSURE

The present disclosure generally relates to communication and feedback platforms. Certain embodiments provide a system and method for efficient messaging and for populating activity streams in a feedback platform.

### BACKGROUND

The statements in this section merely provide background information related to the present disclosure and may not constitute prior art.

In a social network, an activity stream is a list of recent activities performed by a user, such as posting a message, or checking in to a local business establishment. Popular activity streams include a “news feed” on the social network operated by Facebook® social network (available from Facebook, Inc. of Menlo Park, Calif.), a “feed” on the Twitter® social network (available from Twitter, Inc. of San Francisco, Calif.), and a list of “check-ins” on the Foursquare® social network (available from Foursquare Labs, Inc. of New York, N.Y.). Conventionally, messages or activities posted to an activity stream are displayed in chronological order so that more recent messages are more visible to a viewer of the activity stream. Older messages or other items may include important or relevant content but when crowded out by more recent messages, may cause frustration, reduced engagement, and increased network traffic in order to locate the content.

Moreover, techniques have been developed to gather activities or messages from various activity streams that relate to the same topic. For example, messages marked with a keyword or topic prefixed by a hashtag symbol may be displayed together on the Twitter social network. When used to gather messages or activities related to businesses, products, or services, however, such methods may not expose relevant or important content for reasons owing to the diversity of keywords and topics, “tagging” limitations, limitations of search queries, and, in many cases, one or more privacy settings of the online social network.

With respect to “tagging”, conventional messaging options on online social networks are designed to promote personal as opposed to customer-to-business communication, and systems for tagging, or appending relevant information to a message, are designed with personal communication in mind. Typically, users can add photos or “tag” locations to a message on a multitude of social networks. On the Foursquare social network, users can tag friends to a check-in to let others know who they are at a location with. However, in a commercial setting, much of the relevant information a customer would want to reflect in a message is not available to be quickly ‘tagged’ or appended to a message. Conventionally, social networks do not enable business users to make certain sets of relevant information available for tagging, some of which information (for example, employee names and photos) raise privacy considerations and could only be made appropriately available assuming the presence of appropriate privacy controls. Nor do conventional social networks enable a broad system of economic incentives whereby businesses can incent customers to provide them with valuable feedback. This lack of ease and incentives may reduce messaging efficiency and negatively impact the quality of communication and information for customer-users, employee-users and business-users alike.

With respect to privacy in particular, conventionally all comments made on an online social network are posted to a public activity feed and are publicly available. It is difficult and cumbersome for users of online social networks to communicate privately, particularly in the case of customer-to-business relationships where the users do not share a pre-existing relationship. For example, “tips” made about a business on the Foursquare social network are publicly viewable. Meanwhile, on the Twitter social network, each of two users must first elect to “follow” one another in order to enable private, direct messaging functionality. For example, a customer cannot send a business a private message on Twitter unless that business first opts to follow the customer. Such limitations on privacy, and the lack of a robust environment for private activity feeds may limit the quantity, quality and speed of communication through online social networks, and may also limit the productive use of such information.

Improvements in social networks and systems and methods for efficient messaging, and for populating activity streams are desirable.

The foregoing examples of the related art and limitations related thereto are intended to be illustrative and not exclusive. Other limitations of the related art will become apparent to those of skill in the art upon a reading of the specification and a study of the drawings.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products for efficient messaging and for populating activity streams. In an aspect, a communication and feedback platform is disclosed which enables business users to make business-specific information readily available for customer tagging, including appropriate privacy controls, and which enables customers to provide public or private feedback messages to a business. Feedback messages may be tagged with employee information, thereby enabling the business to receive information about the performance of a specific employee via the platform. The platform further comprises a points allocation module, the points being redeemable via a reward engine.

Further features and advantages of the present disclosure, as well as the structure and operations of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of a system for efficient messaging and for populating activity streams in social network, according to an aspect of the present disclosure.

FIG. 2 is a flowchart illustrating a method for efficient messaging and for populating an activity stream in a social network, according to an aspect of the present disclosure.

FIG. 3 is a flowchart illustrating a method for efficient messaging and for populating an activity stream with tagged employees, according to an aspect of the present disclosure.

FIG. 4 is a flowchart illustrating a method for efficient messaging and for populating an activity stream with available rewards, according to an aspect of the present disclosure.

FIG. 5 is a block diagram of an exemplary computer system useful for implementing various aspects disclosed herein.

### DETAILED DESCRIPTION

Throughout the following description, specific details are set forth in order to provide a more thorough understanding to persons skilled in the art. However, well-known elements may not be shown or described in detail to avoid unnecessarily obscuring the disclosure. Accordingly, the description and drawings are to be regarded in an illustrative, rather than a restrictive, sense.

This disclosure relates generally to communication and feedback platforms, and particularly to systems and methods for efficient messaging and for populating activity streams within such systems.

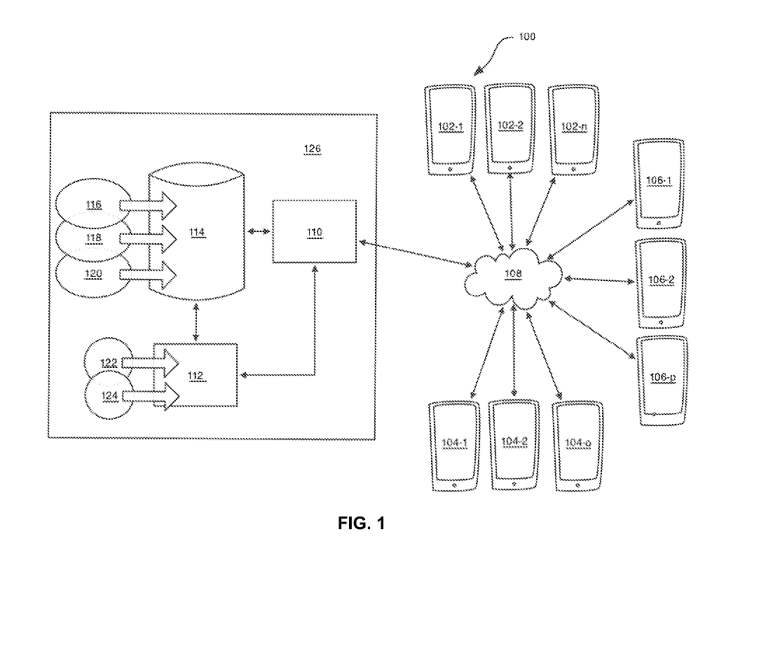

A block diagram of an example of a system 100 for efficient messaging and for populating activity streams in a social network is shown in FIG. 1. According to this example, the system 100 includes a plurality of business devices 102-1, 102-2, . . . 102-n (generically referred to herein as “business device 102” and collectively as “business devices 102”), a plurality of customer devices 104-1, 104-2, . . . 104-0 (generically referred to herein as “customer device 104” and collectively as “customer devices 104”), and a plurality of employee devices 106-1, 106-2, . . . 106-p (generically referred to herein as “employee device 106” and collectively as “employee devices 106”), all of which are connected to a core server 126 via a network 108. A business device 102 is associated with a commercial business, product, or service. Each business device 102 may be associated with one or more employee devices 106.

The core server 126 is configured to perform social network service operations. For example, the core server 126 processes messages and other transactions between any of the customer devices 104, the business devices 102, and the employee devices 106.

The core server 126 is typically a server or mainframe within a housing containing an arrangement of one or more processors 112, volatile memory (i.e., random access memory or RAM), persistent memory (i.e., hard disk devices), and a network interface 110 (to allow the core server 126 to communicate over the network 108) all of which are interconnected by a bus. Many computing environments implementing the core server 126 or components thereof are within the scope of the invention.

The core server 126 is typically connected to other computing infrastructure associated with the social network, including displays, printers, data warehouse or file servers, and the like.

Any of the core server 126, the customer devices 104, the business devices 102, and the employee devices 106 may include a keyboard, mouse, touch-sensitive display (or other input devices), a monitor (or display, such as the touch-sensitive display, or other output devices). According to one example, the customer devices 104, the business devices 102, and the employee devices 106 are smartphones that include a global positioning system device or other means of ascertaining a device location. According to some examples, the customer device 104, the business device 102, and the employee device 106 may be the same device.

In one example, the core server 126 includes a data storage 114 that maintains records representing one or more customer profiles 116, business profiles 118, and employee profiles 120. The data storage may also store messages and records of other transactions between one or more of the customer devices 104, business devices 102, and employee devices 106.

A business profile may be associated with one or more employee profile(s). A tagging engine 122 may provide the processor 112 with logic to process requests from the customer devices 104 by sending notification(s) and updating the employee profile(s).

An analytics engine 124 may provide the processor 112 with logic to permit business devices 102 to view business intelligence information derived from transactions (e.g., messages from the customer devices 104, including messages tagged with employee profile(s)). The analytics engine 124 allows messages from customers and employee performance to be appreciated and proactively managed, acting as a performance management tool.

The functioning of the processor 112 may also be determined by a reward engine (not shown). In one example, a customer profile 116 may include a points balance. Upon receipt or detection of a message from a customer device 104 (associated with a customer profile 116) to a business device 102 (associated with a business profile 118), the reward engine may update the customer profile 116 by updating a points balance (e.g., to provide the customer with immediate gratification for having sent the message).

In another example, an employee profile 120 may include a points balance. Upon receipt or detection of a tag from a customer device 104 (associated with a customer profile 116) of an employee device 106 (associated with an employee profile 120), the reward engine may update the employee profile 120 by updating a points balance (e.g., to provide the employee with a reward for having been tagged).

The reward engine may generate a list of available auction items that may be available in the immediate vicinity of the customer device 104. The list of auction items may be made up of items placed by local businesses to attract the attention of customers in their immediate vicinity. The reward engine matches bids to auction items, enabling the market to clear and facilitating the distribution of rewards for a vacillating amount of points (for example, a free appetizer may cost 160 points at one time, but at another time may cost 360 points. The resulting price may depend on the number of bids, bidders, and quality/quantity of other auction items). Upon receipt of a winning bid indication, the reward engine fulfills the bid and updates the points balance. In this specification, creation or posting of a “reward” is considered a transaction and may be populated in one or more activity streams of the business device 102 (and/or associated business profile 118).

The reward engine also provides logic for an interface for a business device 102 to reply to the message, to update the customer profile 116 (or employee profile 120) with a reward (e.g. direct rewards such as gift cards or items), or to tag the customer profile as a regular customer, etc.

According to one example, the customer device 104 is loaded with a customer application that includes a number of functions. These functions include sending “Feedback messages” and “Note” messages to a business device 102 via the core server 126, receiving responses to such messages, classifying the business as a “Favourite”, managing a points balance, interacting with other customers, etc.

According to one example, the employee device 106 is loaded with an employee application that includes a number of functions. These functions include managing a points balance (e.g. received for great service).

According to one example, the business device 102 (and in some examples, the employee device 106) is loaded with an administrative application that includes a number of functions. For example, a business device 102 may be presented with options to publish feedback messages, tag or classify one or more customer profiles 116 as “Regulars”, create or facilitate the creation of employee profiles 120, create and/or award “Rewards” to customer profiles 116 (and/or employee profiles 120) for their engagement. In one example, the functions of the administrative application may be divided or separated into one or more applications. According to this example, a first administrative application may permit business devices 102 to publish feedback messages, while a second administrative application may facilitate other administrative functions. According to other examples, the administrative application (or a component thereof, such as the first application) and the customer application (and/or the employee application) may be the same application, with a different presentation or screen for various functions.

The following glossary describes this functionality in greater detail.

### GLOSSARY

Feedback Message: Feedback message is the general name for feedback that a customer may give to a business. A feedback message may include a “Note” (see below), a Comment, a Photo, and/or a Tagged Employee. A customer may mark a feedback message public or private. In one example, when the feedback message includes a Note, the Note may be added to the Note count for the Business. Feedback message elements (e.g. Comment, Photo, Tagged Employee) are sent to the Business device. The Business device may then act on individual Feedback messages (e.g. Publish, Reply, Ignore, Send a Reward). If a Customer has marked an individual Feedback message as private, then the Business device is not able to Publish the Feedback message. This allows the Customer the option to determine the privacy status of Feedback messages between the Customer and the Business. The Feedback messages may be viewed on the activity screens of the Customer's followers. If a Customer has marked a Feedback message as private, then the Customer's followers are also not able to view the Feedback message. Customer messages that a Business opts not to Publish are only viewable through the Customer's account (for example, by the Customer's followers) and are not posted on the Business's activity feed. The public viewing of some business and/or employee profile elements may be controlled by the account holder (i.e., businesses or employees may choose whether employee photos associated with a business profile may be viewed by users generally, or only while a user is on location at the business premises; and may also choose whether employee names or profiles are publicly viewable when tagged to a Feedback message).

Note: A Note is a token of appreciation that a Customer may send as a part of a Feedback message. In one example, there are three types of notes: People (Service), Place (Atmosphere}, Product (Food, etc.).

Favourite: A customer may “Favourite” a Business. In one example, there may be a maximum number of favourite Businesses per Customer. A Customer's list of “Favourites” may be organic and change over time. When a Customer “Favourite's” a Business, the Customer may open a line of communication with that Business, allowing the Business to send direct messages and “Rewards” (see below). In one example, a Business may only send Rewards to Customers who have “Favourited” them, or as a response to a Customer's Feedback message. A Customer's Favourite Businesses may be publicly viewable on the Customer's profile.

Regular: A Regular Status may be given by a Business to a Customer. When a Business sends a “Regular Status invite”, the Customer may accept the invite in order to become a Regular. Customers with Regular Status may be sent invites and special rewards. In one example, each Business may have a limited number of Regular Status to be given.

Feedback Message Points (Points): Points may be awarded to Customers for sending Feedback messages, later to be spent bidding on “Auctions” (see below). Customers may receive initial points for sending Feedback messages and adding photos, and if a Feedback message is published or replied to, they may earn extra Points.

Reward: A Reward is a Gift created by the Business (e.g. on a Web interface) and may be sent to a Customer in one of two ways. Firstly, a Business may directly send Rewards to Customers who have Favourited that Business or as a direct response to a Feedback message from a Customer. Secondly, the Reward may be posted as an “Auction” (see below) for viewing by all Customers. Rewards may come in the form of “Gift cards” (e.g. $10 Voucher), or “Free Item Tickets” (e.g. 1 Free Appetizer).

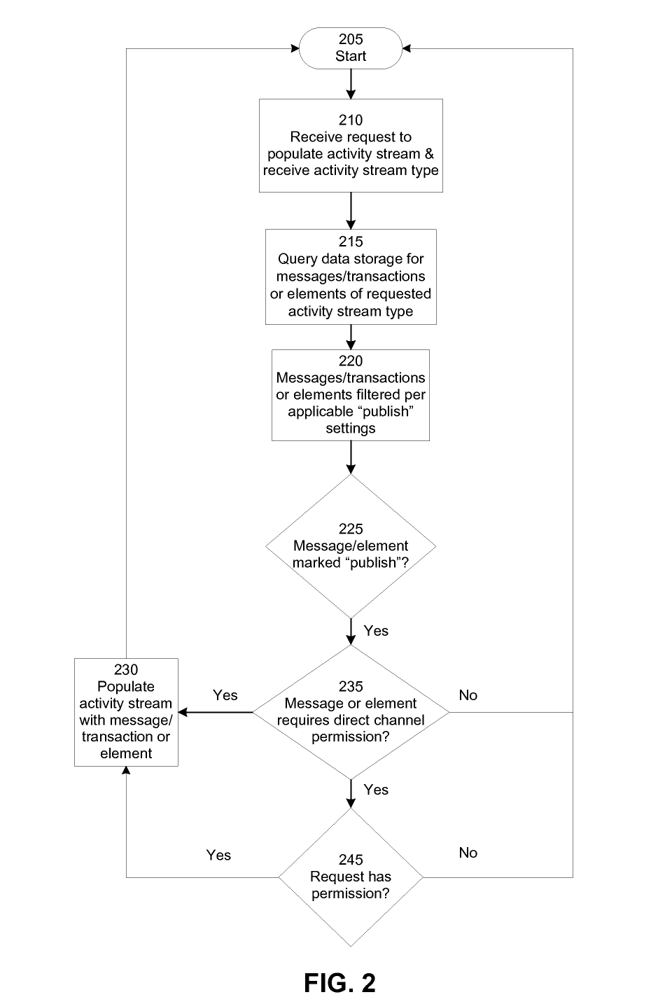

Auction: An auction system permits Businesses to reach Customers who may not have Favourited them or provided a Feedback message. In one example of an open auction system, Businesses may reach through a Web interface and select a number of created Rewards, specify auction details (e.g. Duration, Starting price, Quantity), and post the Auction. A Customer reaches the auction interface through a “Redeem” tab, and can bid on the Auction with Points. A flowchart illustrating an example of a disclosed method of efficient messaging and populating activity streams is shown in FIG. 2. This method may be carried out by software executed by, for example, the processor of the core server 126. Coding of software for carrying out such a method is within the scope of a person of ordinary skill in the art given the present description. The methods may contain additional or fewer processes than shown and/or described, and may be performed in a different order. Computer-readable code executable by at least one processor of the core server 126 to perform the methods may be stored in a computer-readable storage medium, such as a non-transitory computer-readable medium.

With reference to FIG. 2, the method 200 starts at 205 and, at 210, the core server 126 receives a request to populate an activity stream from the customer device 104 (or in some examples, the business device 102 or employee device 106). At 210, the core server receives an indication of the requested activity stream type (e.g. You, Friends, Profile, Favourites, Regular Status, Business Profile, Business Profile—Employees, Auctions, Auction Bids & Comments, Rewards, Employee Tags, etc.). At 215, the core server 126 queries the data storage 114 for messages or transactions (or elements thereof) related to the requested activity stream limited to the activity stream type. At 220, the messages or transactions may be filtered according to publish settings for the message or transaction. The publish settings determine whether the message or transaction has been marked, in the case of customer Feedback Messages, “public” or “private,” or, in the case of business decisions to publish a Feedback message to their business profile, “publish” or “do not publish.” According to one example, the publish settings are determined by the customer device 104, the business device 102, the employee device 106 (where employees have been granted administrative privileges by a business), or some combination. For example, if the message or transaction has been marked as “public” by the customer device and if the message or transaction has been marked as “publish” by the business (or employee device), and if the message contains no elements or targeted recipients subject to additional privacy restrictions (i.e., the message, transaction or an element therein does not require “direct channel permission” at 235; see below), then all elements of the message may be populated in any relevant activity stream at 230. If the message or transaction has been marked as “public” by the customer device but as “do not publish” by a business (or employee device), then the message would only be published in certain requested activity streams (e.g., Friends, Profile, Customer Strums), but not in others (e.g., Business Profile). And if the message has been marked as “private” by the customer device, then it may not be “published” by the business (or employee device), and it would only be published in the customer's own history when viewed by the customer (i.e., Profile activity stream) and in the business's history when viewed by the business or employees with privileges (i.e., Customer Messages activity stream).

Direct channel permission exists where a customer has granted a business permission to send them communications (e.g., rewards, messages, notifications). If the customer ‘favourites’ a business, then the business may send the customer rewards. If a business grants a customer ‘regular’ status, and the customer accepts such status, the customer may receive special benefits at the business and the business may send the customer a message at any time.

Direct channel permission may also exist regarding employee tags. In an example, at the option of the business (or the employee), the business can choose to associate employee profiles with its business profile, and the business or employee can choose to allow customers to view employee profiles when the customers are off of the business premises. Furthermore, the employee or business can separately decide whether users are able to publicly view employee profile information such as an employee name or an employee photo that has been ‘tagged’ to customer messages, (e.g., when a customer compliments and employee for great service by ‘Noting’ the employee for Great Service).

At 235, the server queries whether the message or transaction element, or the message or transaction recipient, requires direct channel permission; and if so, at 245, queries whether such direct channel permission is present. If so, the message (or transaction or element) is populated in the given activity stream. If not, the message (or transaction or element) returns to 210.

Advantageously, the method 200 includes populating an activity stream to facilitate the dissemination of messages or transactions received by customers (e.g. customer feedback). Different activity streams may be populated according to the type of activity stream, the publish settings for the message or transaction and the direct channel permission settings. It will be appreciated that a diversity of activity streams may be populated: a public activity stream, a private activity stream, a selectively private activity stream, etc. The activity stream may thus be controlled by the customer device 104, the business device 102, and in some examples, the employee device 106 (e.g., where the employee device has been granted administrative rights by the business device), and by direct channel permissions. Further advantages derive from permitting messages to be marked public or private, from permitting activities to be compartmentalized into activity stream types, and/or from permitting privacy controls to be placed on certain message paths or message elements. For example, enhancing the quantity, quality and efficiency of communication and the strength of the customer to employee relationship, to provide enhanced and enriched access to content of interest, to at least partially reduce network traffic, bandwidth, and other costs associated with locating this content.

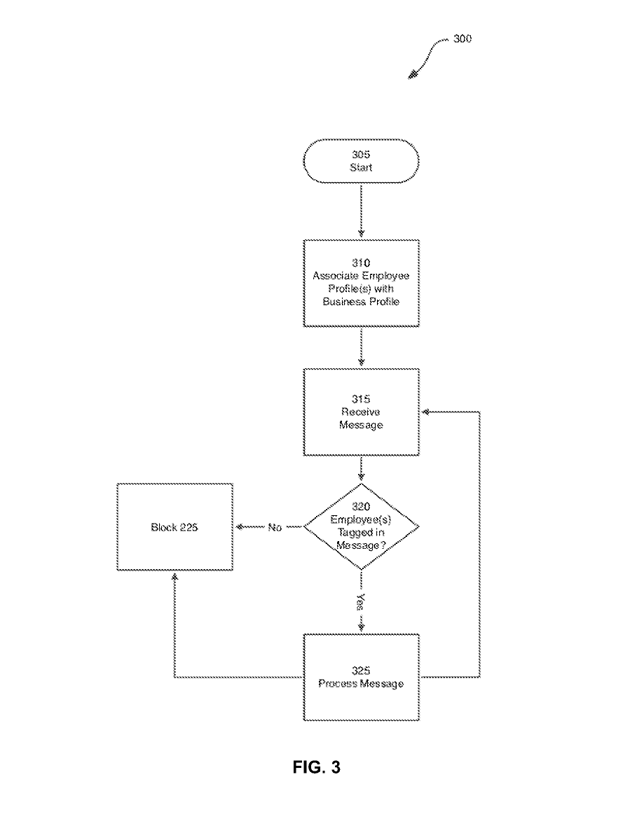

A flowchart illustrating an example of a disclosed method of efficient messaging and populating an activity stream with tagged employees is shown in FIG. 3. The method starts at 305, and at 310, one or more employee profiles 120 may be associated with a business profile 118, and the ability to view such employee profiles may be geographically restricted to the immediate vicinity of the business premise, by sending commands to the core server 126. At 315, the core server 126 receives a message (or other transaction) related to the business profile 118. At 320, the core server determines if one of the employee profiles 120 has been tagged in the message. If so, then at 325 the message is processed. Processing may include sending notifications or moderation, etc. by the employee device and/or business device. After processing, the method continues at block 225 of FIG. 2. At 225, according to one example, all employee tags are marked “do not publish” by default. At 235, according to this example, direct channel permission to view employee tags is limited to the business device 106 associated with the business profile 118 and the customer device 104 responsible for tagging the received message (which customer device may further by limited, for example, by having permission to view only the first name of the tagged employee and not the employee profile).

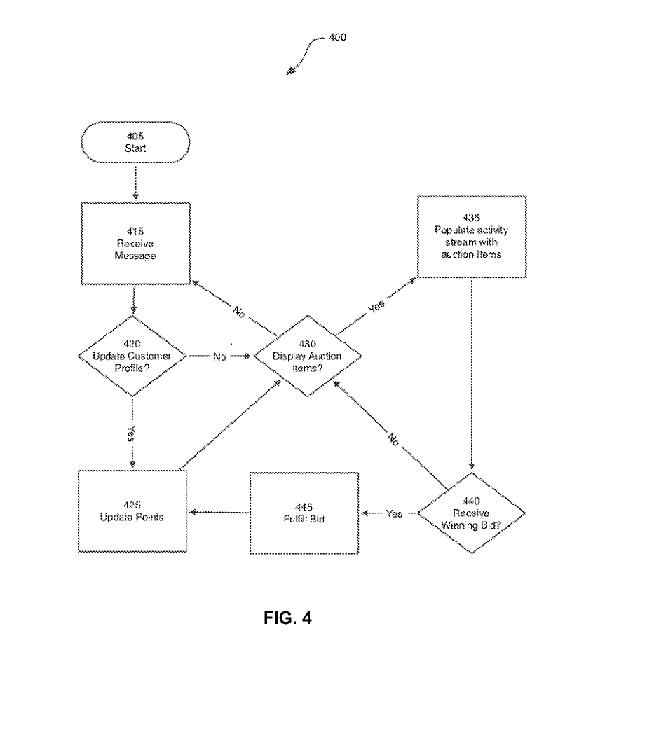

A flowchart illustrating an example of a disclosed method of efficient messaging and populating an activity stream with available rewards is shown in FIG. 4. The method starts at 405, and at 415, the core server 126 receives a message (or other transaction) from a customer device 104. At 420, upon receipt of the message, the reward engine of the core server 126 may update the customer profile 116 (and/or the employee profile 120 if tagged in the message) by updating a points balance at 425. At 430, the reward engine may display a list of available auction items (e.g., in the immediate vicinity of the device that sent the received message). The items may be populated in an activity stream according to the method of FIG. 2. Upon receipt of a bid at 440, the reward engine, updates the points balance at 425, and returns to step 430. Upon conclusion of the auction, the reward engine fulfills the bid at 445 and returns to step 430.

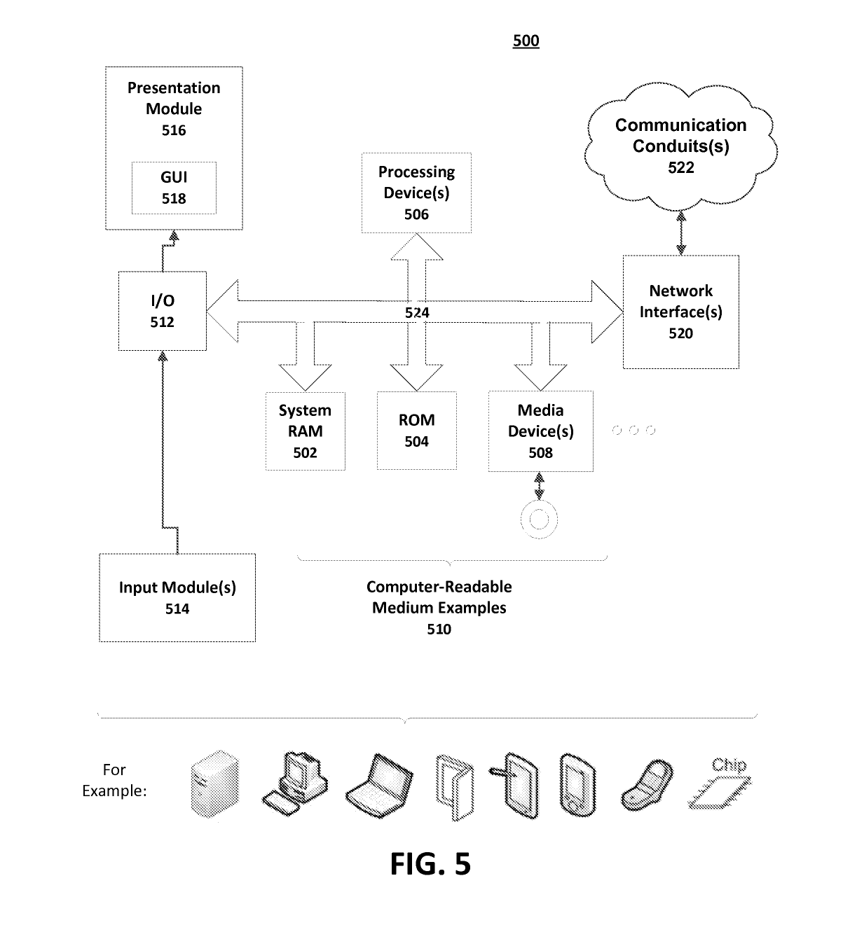

Referring now to FIG. 5, a block diagram of an exemplary computer system useful for implementing various aspects the processes disclosed herein, in accordance with one or more aspects of the present disclosure, is shown.

That is, FIG. 5 sets forth illustrative computing functionality 500 that may be used to implement core server 126, one or more business devices 102, one or more customer devices 104, one or more employee devices 106, or any other component of system 100. In all cases, computing functionality 500 represents one or more physical and tangible processing mechanisms.

Computing functionality 500 may comprise volatile and non-volatile memory, such as RAM 502 and ROM 504, as well as one or more processing devices 506 (e.g., one or more central processing units (CPUs), one or more graphical processing units (GPUs), and the like). Computing functionality 500 also optionally comprises various media devices 508, such as a hard disk module, an optical disk module, and so forth. Computing functionality 500 may perform various operations identified above when the processing device(s) 506 executes instructions that are maintained by memory (e.g., RAM 502, ROM 504, and the like).

More generally, instructions and other information may be stored on any computer readable medium 510, including, but not limited to, static memory storage devices, magnetic storage devices, and optical storage devices. The term “computer readable medium” also encompasses plural storage devices. In all cases, computer readable medium 510 represents some form of physical and tangible entity. By way of example, and not limitation, computer readable medium 510 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 502, ROM 504, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 500 may also comprise an input/output module 512 for receiving various inputs (via input modules 514), and for providing various outputs (via one or more output modules). One particular output mechanism may be a presentation module 516 and an associated GUI 518. Computing functionality 500 may also include one or more network interfaces 520 for exchanging data with other devices via one or more communication conduits 522. In some aspects, one or more communication buses 524 communicatively couple the above-described components together.

Communication conduit(s) 522 may be implemented in any manner (e.g., by a local area network, a wide area network (e.g., network 108, the Internet), and the like, or any combination thereof). Communication conduit(s) 522 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 5. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein, implemented outside of a social network, implemented as a standalone customer satisfaction platform). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer implemented method for facilitating efficient messaging and populating an activity stream, the method comprising:
(a) receiving a request to populate an activity stream;
(b) receiving a requested activity stream type indication related to the request to populate the activity stream;
(c) querying a data storage for at least one transaction of the requested activity stream type;
(d) determining a publish setting for the at least one transaction;
(e) determining a direct channel permission setting for the at least one transaction; and
(f) populating the at least one transaction in the activity stream for display on an electronic device.

2. The method of claim 1 wherein the activity stream type comprises one of: a customer message; an employee tag; a customer status; and a reward item.

3. The method of claim 2, wherein the customer status comprises one of: a favourite status; and a regular status.

4. The method of claim 3, wherein the customer status is the regular status, the method further comprising the step of:
(g) sending the customer a business message, the business message originating from a business.

5. The method of claim 1 wherein the at least one transaction comprises one of: a customer message; and a customer message element.

6. The method of claim 1 wherein, in the case of a message, the publish setting comprises one of: a private setting, and a public setting.

7. The method of claim 1 wherein, in the case of a decision by a business whether or not to publish a message to its business profile, the publish setting comprises one of: publish, and do not publish.

8. The method of claim 6, wherein the private setting corresponds to the at least one transaction being only viewable on a business device; on an employee device which has been granted administrative privileges; and the sending device.

9. The method of claim 7, wherein the publish setting corresponds to the at least one transaction not being viewable on the subject business' public profile, but only through activity feeds displaying the customer message, e.g., the customer's Profile, the Friends activity feed of the customer's followers.

10. The method of claim 1 wherein the direct channel permission setting is determined from a direct channel profile match between a requesting device and a device that made the at least one transaction.

11. The method of claim 10, further comprising the step of:
(g) exchanging at least one message between the requesting device and the device that made the at least one transaction;
wherein at least one message is exchanged if the direct channel permission setting allows the exchange.

12. The method of claim 1, wherein the request comprises location-specific feedback.

13. A system for facilitating efficient messaging and populating an activity stream, the system comprising:
(a) a core server having a processor and connected to a data storage for administration of one or more user profiles including customer profiles, business profiles and employee profiles, a processor of the core server is configured to:
(i) receive a request to populate an activity stream from an electronic device having a display;
(ii) receive an indication of the requested activity stream type;
(iii) query the data storage for at least one transaction of the requested activity stream type;
(iv) determine a publish setting for the at least one transaction;
(v) determine a direct channel permission setting for the transaction based on the one or more customer profiles, business profiles, and employee profiles; and
(vi) in response to the determining steps, populate the at least one transaction in the activity stream for display on the electronic device.

14. The system of claim 13, wherein the user profiles includes a points balance and the processor of the core server is further configured to
(vii) update the points balance of one or more user profiles, populate auction items in the activity stream, and manage and fulfill bids.

15. One or more computer storage media having stored thereon multiple instructions that facilitate efficient messaging and populating an activity stream by, when executed by one or more processors of a computing device, causing the one or more processors to:
(a) receive a request to populate an activity stream;
(b) receive a requested activity stream type indication related to the request to populate the activity stream;
(c) query a data storage for at least one transaction of the requested activity stream type;
(d) determine a publish setting for the at least one transaction;
(e) determine a direct channel permission setting for the at least one transaction; and
(f) populate the at least one transaction in the activity stream for display on an electronic device.

16. One or more computer storage media as recited in claim 15, wherein the activity stream type comprises one of: a customer message; an employee tag; a customer status; and a reward item.

17. One or more computer storage media as recited in claim 16, wherein the customer status comprises one of: a favourite status; and a regular status.

18. One or more computer storage media as recited in claim 15, wherein the customer status is the regular status, the method further comprising the step of:
(g) sending the customer a business message, the business message originating from a business.

19. One or more computer storage media as recited in claim 15, wherein the at least one transaction comprises one of: a customer message; and a customer message element.

20. One or more computer storage media as recited in claim 15, wherein, in the case of a message, the publish setting comprises one of: a private setting and a public setting.

21. One or more computer storage media as recited in claim 15, wherein, in the case of a decision by a business whether or not to publish a message to its business profile, the publish setting comprises one of: publish and do not publish.

22. One or more computer storage media as recited in claim 15, wherein the direct channel permission setting is determined from a direct channel profile match between a requesting device and a device that made the at least one transaction.

23. One or more computer storage media as recited in claim 15, wherein the multiple instructions further cause one or more processors to:
(g) exchange at least one message between the requesting device and the device that made the at least one transaction;
wherein at least one message is exchanged if the direct channel permission setting allows the exchange.
